(19) United States
(12) Patent Application Publication
(10) Pub. No.: US 2021/0323054 A1
(43) Pub. Date: Oct. 21, 2021

(54) Frequency Mapping for Magnetohydrodynamic Jetting of Metals in 3D Printing Applications

(71) Applicant: Desktop Metal, Inc., Burlington, MA (US)

(72) Inventors: Mark Gardner Gibson, Carlisle, MA (US); Emanuel Michael Sachs, Newton, MA (US)

(73) Assignee: Desktop Metal, Inc., Burlington, MA (US)

(21) Appl. No.: 17/232,368

(22) Filed: Apr. 16, 2021

Related U.S. Application Data
(60) Provisional application No. 63/010,747, filed on Apr. 16, 2020.

(51) Int. Cl. B22D 23/00; B33Y 10/00; B33Y 50/02; B33Y 30/00

(52) U.S. Cl. CPC B22D 23/003; B33Y 30/00; B33Y 50/02; B33Y 10/00

(57) ABSTRACT

A method of developing a frequency map for an MHD jetting nozzle includes filling the MHD jetting nozzle with a liquid metal. The MHD jetting nozzle is excited with a series of jetting pulses delivered at a range of frequencies the vibration response of the MHD jetting nozzle and/or a meniscus of jetting material is measured.

### CROSS-REFERENCE TO RELATED APPLICATION

This application claims the benefit under 35 U.S.C. § 119(e) of U.S. Provisional Application No. 63/010,747 filed Apr. 16, 2020, all of which are herein incorporated by reference in their entirety.

### FIELD OF THE DISCLOSURE

The subject matter of the present disclosure generally relates to magnetohydrodynamic jetting for additive manufacturing, and more particularly relates to ameliorating negative effects of jetting frequency during magnetohydrodynamic jetting.

### BACKGROUND OF THE DISCLOSURE

Controlled magnetohydrodynamic pulsing may be used to selectively jet individual drops of molten metals and additively build up three-dimensional geometries, in a process known as magnetohydrodynamic printing (here referred to as MHD printing, or MHD). In one embodiment of this process, a jetting apparatus (here referred to as the nozzle assembly) is employed to heat solid metal feedstock above its liquidus temperature to create molten metal, contain the molten metal, keep the molten metal above its liquidus temperature, position the body of molten metal relative to a magnetic field, enable an electric current to be passed through the molten metal to create a magnetohydrodynamic pulse, and direct the flow of molten metal towards the desired target. Certain magnetohydrodynamic printing concepts and apparatus are disclosed by U.S. Pat. No. 10,201,854, entitled “Magnetohydrodynamic deposition of metal in manufacturing” and filed Mar. 6, 2017, the contents of which are incorporated herein in their entirety.

In some embodiments of MHD printing, the jetting frequency—the rate at which pulses of current are applied through the nozzle to eject drops—may need to be varied substantially with parameters such as the relative motion of printhead and part being printed, nozzle temperature, desired drop size, or others. It has been observed that several characteristics of the jetting such as the ejection velocity of droplets produced, the angle of the resulting stream of drops, the drop size, the presence or absence of so-called “satellite” or secondary drops, as well as the drop-to-drop variation in the above quantities, can vary significantly with jetting frequency. As in most engineering and manufacturing processes, some variation in MHD jetting characteristics is unavoidable and tolerable. However, when the variations are too great, the ability to print high-quality parts is adversely affected.

As a non-limiting example, the acceptable range of drop velocities might be 1.8 m/s +/−0.2 m/s, the acceptable drop-to-drop variation in trajectory might be 0.2°, and the allowable number of satellite drops might be specified as “less than 10 per 100,000 drops jetted”. Similar specifications could exist for each of the relevant parameters.

During MHD printing, cyclical vibrations may be induced in the nozzle by the Lorentz forces used by the jetting process. Nearly all physical objects, alone and in combination with other objects, demonstrate natural frequencies at which they respond to cyclical vibrations, and the natural frequencies of multiple objects attached to each other can combine and interact in complex ways. In an MHD system, the relevant objects in question may include the nozzle, the electrical terminals providing current flow through the nozzle, the heating elements providing heat to the nozzle, the structural elements supporting the nozzle, and other components mechanically attached to the nozzle or combined with the nozzle, referred to here as the nozzle assembly, and the fluid bodies within and on the outside surface of the nozzle assembly. The complex natural frequency response of the described system of parts in an MHD jetting system, is likely a contributing cause of the frequency-dependent behavior described above. For example, a correlation may be observed between observable evidence of resonance effects (e.g. a high amplitude of physical oscillation at a given frequency relative to the same quantity at other frequencies), and certain undesirable jetting behaviors as described above.

It is interesting to contrast the situation in MHD jetting of molten metal with more conventional drop-on-demand printing of inks. In jetting molten metal, oscillation of the meniscus after a droplet is fired is inherently a much more challenging problem for several reasons. First, owing to the higher density of molten metal, the mass of moving liquid in a meniscus of a given size is substantially higher in molten metal than in ink and therefore, any oscillation will contain more energy and have a tendency to persist longer. This is severely compounded by the fact, that while in ink printing, the viscosity of the ink can be deliberately increased to speed up the damping of meniscus oscillations, in printing metal, no such viscosity modification is practical and the viscosity of molten metals tends to be quite low, typically around 1 centipoise. This is well below the viscosity range used in ink printing. Further, when applying molten metal to the creation of 3D parts, there is a desire to use droplets which are larger than those used in graphics printing. Such larger droplets are printed form a nozzle with a larger orifice and therefore meniscus. The larger the meniscus, the lower the natural frequency of oscillation of the meniscus after the droplet escapes. If a given number of oscillations must take place before the oscillation damps out, it will take a longer time to do so when the oscillation frequency is low.

Thus MHD printing presents severe challenges as regards the question of damping of meniscus oscillations and therefore the ability to fire the next droplet after the oscillation has damped out.

The subject matter of the present disclosure is directed to overcoming, or at least reducing the effects of, one or more of the problems set forth above.

### BRIEF SUMMARY OF THE DISCLOSURE

Disclosed are methods of developing and using jet-quality maps for MHD jetting. In an embodiment method, the definition of acceptable jetting parameters is defined. An MHD jetting nozzle is affixed to a test fixture or is installed in a printer. The nozzle is filled with liquid metal and then is excited with a series of jetting pulses delivered over a range of frequencies. These pulses can be actual jetting as done during printing or test pulses. The vibration response of at least one of the nozzle and a meniscus of liquid metal on a discharge orifice is then measured. This can be accomplished, in certain embodiments, stroboscopically. The vibration response can be used to create a frequency map digital file which can be stored on a computer readable non-transient storage medium. Based on response behavior, bands of jetting frequency that result in acceptable jetting quality (for example, jetting speed, angle etc. as described above) can be identified and saved in the frequency map digital file. A MHD jetting printer controller can use the frequency map digital file in creating a plan to jet the desired part and/or alter one or more printing parameters during printing. For example the jetting frequency can be controlled to avoid or reduce operating the nozzle in disallowed frequency bands. It should be understood that generally references and disclosure related to detection and amelioration of vibration of the nozzle may be applicable to the detection and amelioration of vibration of the meniscus of liquid metal on the discharge orifice of the nozzle.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a block diagram of an additive manufacturing system for MHD printing molten metal.

FIGS. 2A-C are depictions of the nozzle of the system of FIG. 1.

FIG. 3 is a plot of drop velocity as a function of frequency for an embodiment nozzle.

FIGS. 4A-B depict embodiment testing setups.

FIGS. 5A-B depict nozzles undergoing varying degrees of vibration in the meniscus of material on a discharge orifice.

FIG. 6 depicts the position of a meniscus as a function of time after a jetting pulse.

Like reference numbers and designations in the various drawings indicate like elements.

### DETAILED DESCRIPTION

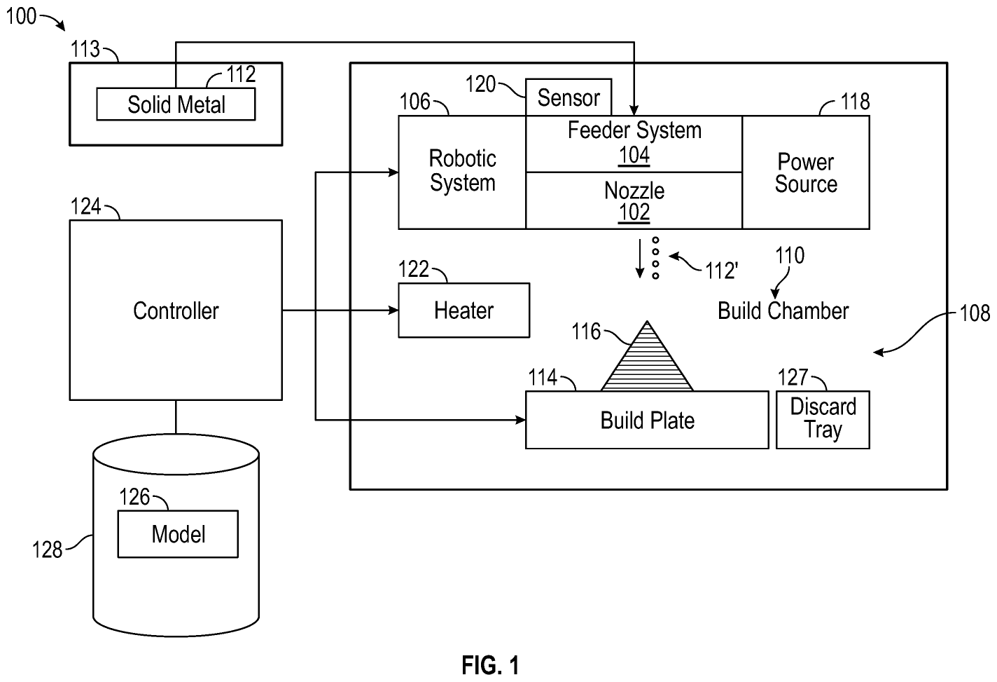

FIG. 1 is a schematic depiction of an additive manufacturing system 100 using MHD printing of liquid metal 100 in which the disclosed improvements may be employed. Additive manufacturing system 100 can include a nozzle 102, a feeder system 104, and a robotic system 106. In general, the robotic system 106 can move the nozzle 102 along a controlled pattern within a working volume 108 of a build chamber 110 as the feeder system 104 moves a solid metal 112 from a metal supply 113 and into the nozzle 102. As described in greater detail below, the solid metal 112 can be melted via heater 122 in or adjacent to the nozzle 102 to form a liquid metal 112′ and, through a combination of a magnetic field and an electric current acting on the liquid metal 112′ in the nozzle 102, MHD forces can eject the liquid metal 112′ from the nozzle 102 in a direction toward a build plate 114 disposed within the build chamber 110. Through repeated ejection of the liquid metal 112′ as the nozzle 102 moves along the controlled pattern, an object 116 (e.g., a two-dimensional object or a three-dimensional object) can be formed. The object may be formed based on a model 126 enacted through a controller 124. In certain embodiments, the object 116 can be moved under the nozzle 102 (e.g., as the nozzle 102 remains stationary). For example, in instances in which the controlled pattern is a three-dimensional pattern, the liquid metal 112′ can be ejected from the nozzle 102 in successive layers to form the object 116 through additive manufacturing. Thus, in general, the feeder system 104 can continuously, or substantially continuously, provide build material to the nozzle 102 as the nozzle 102 ejects the liquid metal 112′, which can facilitate the use of the three-dimensional printer 100 in a variety of manufacturing applications, including high volume manufacturing of metal parts. As also described in greater detail below, MHD forces can be controlled in the nozzle 102 to provide drop-on-demand delivery of the liquid metal 112′ at rates ranging from about one liquid metal drop per hour to thousands of liquid metal drops per second and, in certain instances, to deliver a substantially continuous stream of the liquid metal 112′. A sensor or sensors 120 may monitor the printing process as discussed further below.

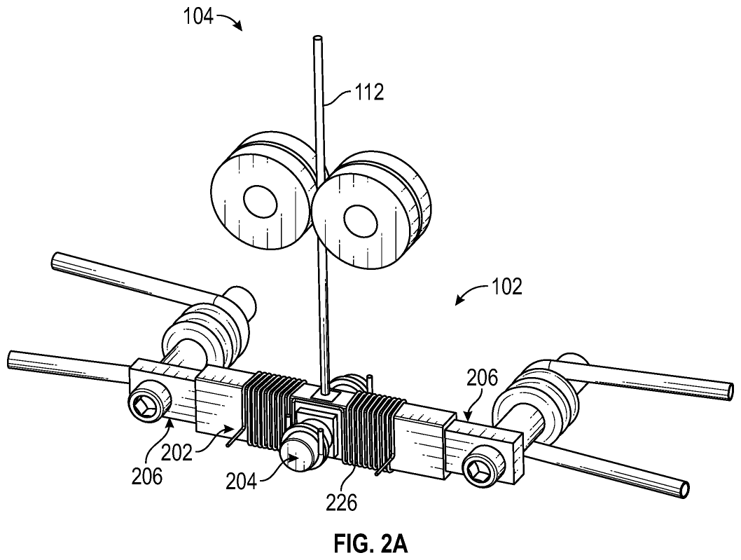

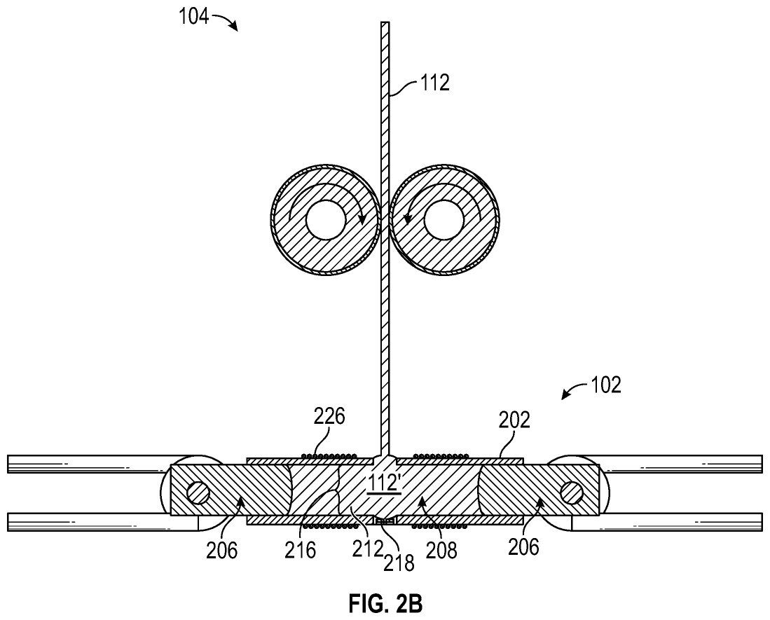

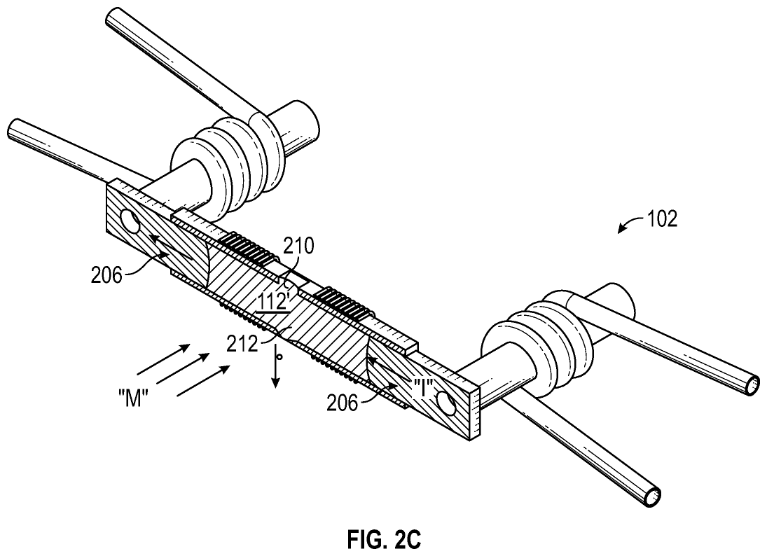

Now with reference to FIGS. 2A-D which depict the nozzle of the printer of FIG. 1. The nozzle can include a housing 202, one or more magnets 204, and electrodes 206. The housing 202 can define at least a portion of a fluid chamber 208 having an inlet region 210 and a discharge region 212. The one or more magnets 204 can be supported on the housing 202 or otherwise in a fixed position relative to the housing 202 with a magnetic field “M” generated by the one or more magnets 204 directed through the housing 202. In particular, the magnetic field can be directed through the housing 202 in a direction intersecting the liquid metal 112′ as the liquid metal 112′ moves from the inlet region 210 to the discharge region 212. Also, or instead, the electrodes 206 can be supported on the housing 202 to define at least a portion of a firing chamber 216 within the fluid chamber 208, between the inlet region 210 and the discharge region 212. In use, the feeder system 104 can engage the solid metal 112 and, additionally or alternatively, can direct the solid metal 112 into the inlet region 210 of the fluid chamber 208 as the liquid metal 112′ is ejected through the discharge orifice 218 through MHD forces generated using the one or more magnets 204 and the electrodes 206. A heater 226 may be employed to heat the housing 202 and the fluid chamber 208 to melt the solid metal 112. A discard tray 127 is located in proximity to the build plate and the nozzle may deposit droplets in it during a testing or calibration step.

In certain implementations, an electric power source 118 can be in electrical communication with the electrodes 206 and can be controlled to produce an electric current “I” flowing between the electrodes 206. In particular, the electric current “I” can intersect the magnetic field “M” in the liquid metal 112′ in the firing chamber 216. It should be understood that the result of this intersection is an MHD force (also known as a Lorentz force) on the liquid metal 112′ at the intersection of the magnetic field “M” and the electric current “I”. Because the direction of the MHD force obeys the right-hand rule, the one or more magnets 204 and the electrodes 206 can be oriented relative to one another to exert the MHD force on the liquid metal 112′ in a predictable direction, such as a direction that can move the liquid metal 112′ toward the discharge region 212. The MHD force on the liquid metal 112′ is of the type known as a body force, as it acts in a distributed manner on the liquid metal 112′ wherever both the electric current “I” is flowing and the magnetic field “M” is present. The aggregation of this body force creates a pressure which can lead to ejection of the liquid metal 112′. It should be appreciated that orienting the magnetic field “M” and the electric current substantially perpendicular to one another and substantially perpendicular to a direction of travel of the liquid metal 112′ from the inlet region 210 to the discharge region 212 can result in the most efficient use of the electric current “I” to eject the liquid metal 112′ through the use of MHD force.

In use, the electrical power source 118 can be controlled to pulse the electric current “I” flowing between the electrodes 206. The pulsation can produce a corresponding pulsation in the MHD force applied to the liquid metal 112′ in the firing chamber 216. If the impulse of the pulsation is sufficient, the pulsation of the MHD force on the liquid metal 112′ in the firing chamber 208 can eject a corresponding droplet from the discharge region 212.

In certain implementations, the pulsed electric current “I” can be driven in a manner to control the shape of a droplet of the liquid metal 112′ exiting the nozzle 102. In particular, because the electric current “I” interacts with the magnetic field “M” according to the right-hand rule, a change in direction (polarity) of the electric current “I” across the firing chamber 216 can change the direction of the MHD force on the liquid metal 112′ along an axis extending between the inlet region 210 and the discharge region 212. Thus, for example, by reversing the polarity of the electric current “I” relative to the polarity associated with ejection of the liquid metal 112′, the electric current “I” can exert a pullback force on the liquid metal 112′ in the fluid chamber 208.

Each pulse can be shaped with a pre-charge that applies a small, pullback force (opposite the direction of ejection of the liquid metal 112′ from the discharge region 212) before creating an ejection drive signal to propel one or more droplets of the liquid metal 112′ from the nozzle 102. In response to this pre-charge, the liquid metal 112′ can be drawn up slightly with respect to the discharge region 212. Drawing the liquid metal 112′ slightly up toward the discharge orifice in this way can provide numerous advantageous, including providing a path in which a bolus of the liquid metal 112′ can accelerate for cleaner separation from the discharge orifice as the bolus of the liquid metal is expelled from the discharge orifice, resulting in a droplet with a more well-behaved (e.g., stable) shape during travel. Similarly, the retracting motion can effectively spring load a forward surface of the liquid metal 112′ by drawing against surface tension of the liquid metal 112′ along the discharge region 212. As the liquid metal 112′ is then subjected to an MHD force to eject the liquid metal 112′, the forces of surface tension can help to accelerate the liquid metal 112′ toward ejection from the discharge region 212.

Further, or instead, each pulse can be shaped to have a small pullback force following the end of the pulse. In such instances, because the pullback force is opposite a direction of travel of the liquid metal 112′ being ejected from the discharge region 212, the small pullback force following the end of the pulse can facilitate clean separation of the liquid metal 112′ along the discharge region 212 from an exiting droplet of the liquid metal 112′. Thus, in some implementations, the drive signal produced by the electrical power source 118 can include a wavelet with a pullback signal to pre-charge the liquid metal 112′, an ejection signal to expel a droplet of the liquid metal, and a pullback signal to separate an exiting droplet of the liquid metal 112′ from the liquid metal 112′ along the discharge region 212. Additionally, or alternatively, the drive signal produced by the electrical power source 118 can include one or more dwells between portions of each pulse.

As used herein, the term “liquid metal” shall be understood to include metals and metal alloys in liquid form and, additionally or alternatively, includes any fluid containing metals and metal alloys in liquid form, unless otherwise specified or made clear by the context. Metals suitable for use with the disclosure include aluminum and aluminum alloys, copper and copper alloys, silver and silver alloys, gold and gold alloys, platinum and platinum alloys, iron and iron alloys, and nickel and nickel alloys.

The current disclosure relates to the quality of MHD jetting as a function of jetting frequency, and methods for correcting or avoiding performance degradations through use of this information.

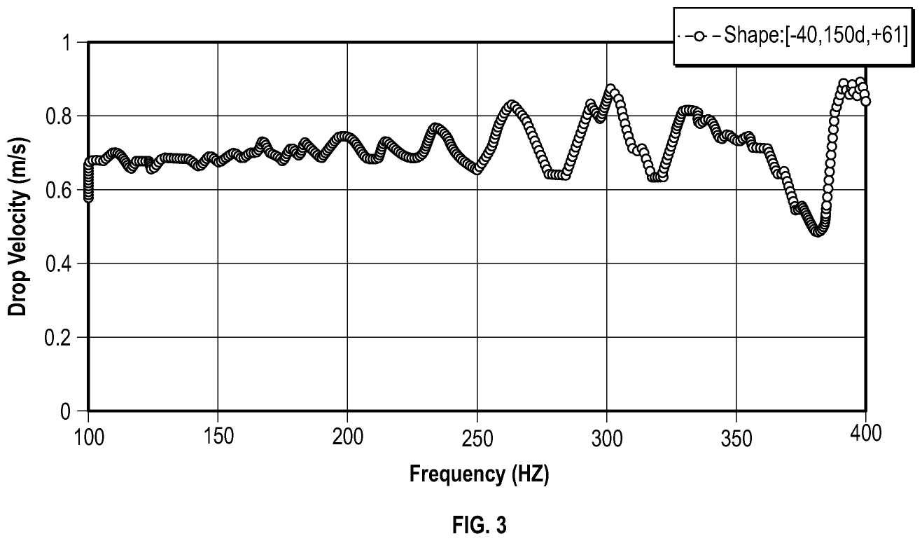

With reference now to FIG. 3, a plot of droplet speed as a function of jetting frequency is displayed, which can be described as a type of frequency response. These data were gathered by operating a single MHD nozzle printing an aluminum alloy and supplying droplet ejection current pulses at known and controlled frequencies. Each droplet ejection current pulse results in the ejection of a single droplet, when working as intended. It should be understood that a droplet ejection current pulse herein may actually consist of two or more closely spaced sub-pulses. For example, a droplet ejection pulse might consist of a sub-pulse which creates a positive pressure within the nozzle so as to cause liquid to accelerate out of the nozzle, followed by a sub-pulse of opposite current polarity which pulls the tail of the emerging droplet back into the nozzle so as make the detachment fast and clean. Between successive droplet ejection current pulses, there is a current-quiescent period during which essentially no current is caused to flow through the nozzle. Increasing the jetting frequency is accomplished by shortening the duration of the current-quiescent period without making substantial alteration to the jetting pulse (or any of the sub-pulses). The droplet speed is determined by capturing stroboscopically illuminated images with a calibrated camera. The strobe is fired so that a given droplet appears two or more times in each camera frame. The distance between these two or more droplet images is measured from the images captured by the camera. As we know the time period between strobe firing, the droplet speed can be calculated. Although not displayed in FIG. 3, comparing successive measurements of droplet speed from successive frames can yield information on the “jitter” of droplet speed. While the plot shows jetting at ˜0.7 m/s jetting has been achieved at speeds significantly above 1.0 m/s—nonetheless, the frequency response issues identified manifest in similar fashion at these speeds.

As seen in FIG. 3, there is a portion of the frequency response in which the drop speed remains relatively constant, being in this case from very low frequency up to approximately 180 Hz. It is not that there is no variation of speed in this region, it is rather that the variation is relatively small. Further, observation of other parameters has shown that they too are well behaved in this range. For example, the jitter in droplet speed does not tend to be influenced by jetting frequency. Multiple drops are not ejected at each pulse, as can sometimes happen at higher frequencies. Emitted droplets are not traveling at so low a speed that two successively ejected droplets collide and coalesce in flight before reaching their target, as can sometime happen at higher frequencies. The angle at which droplets travel after ejection is substantially not a function of droplet frequency, as it can be at higher frequencies. Thus, a part build file—the instructions that the printer will follow to create the part—can be created without special attention to frequency of drop ejection, so long as the frequency remains in this safe region. In particular, if the vector traverse of the nozzle to create the outer perimeter of a part requires that the jetting frequency vary along the length of this vector path, no special process planning will be required and the droplet should be expected to land as desired. (It will be understood that the changing curvatures of a given vector traverse, in combination with the acceleration limits of the motion system used to effect such a traverse may define local limitations to the mechanical speed at which the nozzle or part is moved. It is further understood that it is not desirable to lower the jetting frequency of an entire vector traverse due to a limitation defined by only a portion of it. Hence, jetting frequency will be required to change along the vector traverse.)

As seen in FIG. 3 at frequencies above 180 Hz the jetting will experience widely varying speeds. This occurs for a variety of reasons. First, such speed variation is observed to co-occur with substantial issues related to the dependable arrival of droplets at the target positions. For example, such variation can occur when droplets which are too large. The droplets may be larger than desired because of changes in how the droplets form and detach. The droplets may be too large because two or more droplets have collided to form a larger droplet. The detachment of the droplets from the nozzle may be sufficiently modified so as to no longer be substantially axi-symmetric and therefore to emit droplets at an angle with respect to the nozzle. Without being bound by theory, the variation of droplet speed with frequency may be employed as a proxy for other aspects of jet performance as regards frequency dependence, because this variation is caused by changing dynamics of the meniscus and more generally of the liquid surface during droplet formation and the physics underlying some or all of the other failure modes described.

The droplet speed versus frequency information can be supplemented by other observations which can be made optically, including in the printer. These include counting droplets so as to determine if droplets joined in flight, measuring the angle at which droplets are emitted, and looming for the emission of two or more streams, rather than one. Drop size can also be measured, whether optically or by other methods. This information can be used to determine regions of the frequency spectrum which should be avoided and thereby the remaining regions of the frequency spectrum can be allowed.

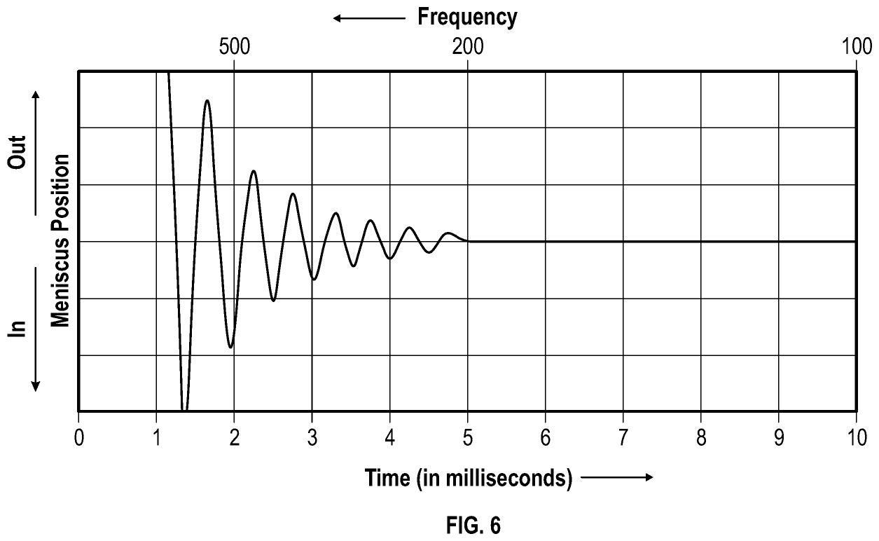

Without being bound by theory, further insight can be gained by looking at FIG. 6 which shows the position of the meniscus immediately after the ejection of a single droplet as measured by laser triangulation. The meniscus position is on the vertical axis. As can be seen, at first the position is off the chart. This is where the meniscus is re-forming after the detachment of the droplet. The meniscus then begins a damped oscillation at a natural frequency of approximately 1800 Hz. After approximately 5 msec, the oscillation has damped out.

The time after the firing pulse is shown on the horizontal axis below the plot. The horizontal axis above the plot shows a corresponding frequency. Thus, for example, if the jet where to be fired at 100 Hz, that would mean that the next firing pulse arrives 10 msec after the previous pulse. One would then be at the right-hand edge of this chart and the meniscus would be completely damped out by this time. Thus, the previous pulse would have no effect on the subsequent pulse, including in altering its speed because the meniscus was bouncing. The same conclusion would follow if the jet were fired at 180 Hz, because by 5.5 msec after a pulse, the meniscus oscillation has died out.

However, at frequencies higher than 200 Hz, the successive pulse will be fired while the meniscus is still oscillating and one can expect that there may be an impact of the meniscus oscillation on the formation of the subsequent droplet, including on its speed. Without limitation, this is a primary mechanism behind the droplet speed frequency response on FIG. 100.

Returning to FIG. 6 and specifically to the time period when the meniscus is still undergoing a damped oscillation, we see that the oscillation takes place around the meniscus position that will eventually be reached when the oscillation is damped out. Typically, the meniscus will be fairly flat at this position, neither bulging out nor cupped inward. However, this equilibrium position need not be totally flat as there may be, and generally will be, some amount of bias pressure in the liquid metal, whether intentionally created or created by a combination of gravitational head and capillary forces. The vertical axis of FIG. 6 is also marked to show when the meniscus is “out” or protruding and when it is “in” or withdrawn a bit into the nozzle as it undergoes its oscillation.

It should be further noted that the effect of the meniscus oscillation on successive drops may depend in a complex way on the position of the meniscus when the next firing pulse starts, the direction of motion of the meniscus at that time, and the speed of motion at that time. Further, the length of the firing pulse can be of the same or similar magnitude at the period of oscillation of the meniscus. For example a typical firing pulse is duration 0.3 msec and the period of oscillation of the meniscus in FIG. 6 is approximately 0.55 msec. For this reason, the effect of meniscus oscillation on successive drops may also depend on where in the process of damping out the successive pulse is initiated.

In this understanding, the frequency response of FIG. 3 is a manifestation of the fact that at different firing frequencies, the length of time between pulses varies inversely with firing frequency. Thus, as the firing frequency is changed, successive firing pulses are initiated at different points in the damped oscillation of the meniscus due to the previous firing pulse. As such, the velocity of the drop ejected can vary as can other important jetting parameters such as droplet direction, drop size, the possibility of two drops combining in flight and other matters discussed above. It should be noted that the frequency response of FIG. 3 may also include other frequency related mechanisms beyond the one described, including the mechanisms mentioned above, and the present disclosure should not be limited by the theory presented above.

In use in the printer, a frequency response such as depicted in FIG. 3 may be measured. Other responses can also be measured and plotted with respect to frequency as discussed above. Criteria can then be applied to determine allowable ranges of frequencies in which to operate. For example, one criterion can be to exclude frequency regions where the droplet speed is particularly low as this is known to be problematic for drop placement, for the possibility of merging in flight, and other reasons. It may also be desirable to eliminate frequency bands where the droplet speed is particularly high as these will also result in drop placement errors and may correspond to smaller droplets—which could also be independently examined with a different measurement.

In certain embodiments, the frequency response can be evaluating during manufacturing of the nozzle assembly. Particularly, the nozzle assembly may be installed in a test fixture, where it may be heated and filled with molten metal, in a manner similar to its use in MHD printing. The nozzle assembly may then be excited by jetting pulses similar to those used during MHD printing. The pulses will be delivered at a range of frequencies, preferably including the range of frequencies typically jetted at during MHD printing. The vibration of the nozzle assembly and/or the fluid bodies within the nozzle assembly may then be measured using a variety of techniques, including high-speed imaging, laser distance measurement, laser displacement measurement, capacitive distance measurement, acceleration measurement, such as with an accelerometer, or other techniques familiar to one skilled in the art. In this manner, a frequency response mapping for the nozzle assembly and/or fluid bodies within the nozzle may be generated.

In other embodiments, the printer itself is provided with the means like those described above for measuring vibration of the nozzle assembly and/or fluid bodies within the nozzle assembly. These could be deployed after a nozzle is installed and/or periodically during the nozzle's life to create and/or update the frequency map. Frequency map generation can also be performed when indicators of changes in nozzle operating condition (such as abrupt changes in jetting speed for a given pulse profile) or other jetting problems are detected.

The frequency map may preferably be stored in a manner that is physically linked to the nozzle assembly. In certain embodiments, the map is stored in an RFID chip attached to the nozzle assembly. In another preferred embodiment, the frequency map is stored remotely—for instance, on a remote server—and the nozzle assembly is provided with a unique identifier such as a serial number that enables the frequency map to be accessed.

One embodiment of applying the information associated with allowable frequency bands is as follows. The perimeter of the part on each layer is defined by relative vector motion of the nozzle and the work piece being built. This is done to attain the best accuracy possible in drop placement. This vector outline could be done entirely below the frequency at which large variations in jet performance occur. As such, the frequency can change during the vector path without consequence to the quality of the build. It may be that there will be several vector paths to define the part perimeter in each layer one inside the previous, or one outside the previous. However, when it comes time to fill the interior of the part on each layer there is less need for precise control of drop placement and other printing parameters. Further, for many parts, the number of drops needed for such infill printing will be larger than the number of drops needed to define the perimeter. Thus, it would be very advantageous to be able to print infill at a high frequency—a frequency where the droplet velocity and other parameters of interest depend strongly on frequency. One embodiment is to print this infill with relative raster motion of the nozzle and the part being printed. This infill could be printed at a frequency within one of the allowable bands derived by inspection of frequency responses such as that of FIG. 6 and but still above the frequency at which meniscus oscillation has stopped completely. In this way, the total time required to print a part could be substantially reduced. Further, it may be that when a raster infill line is long, the highest possible frequency band is used and the nozzle is accelerated to full speed prior to arriving at the spot where printing begins. Whereas for a shorter raster infill line, a lower frequency band is used so that any acceleration distance is reduced and perhaps eliminated.

When the nozzle assembly is installed in an MHD printer, the frequency map may be accessed. The frequency map may then be used during toolpath generation and/or printing to improve jetting performance. In one preferred embodiment, the toolpath generation algorithm is programmed to minimize the time spent jetting at disallowed frequencies. For instance, when the printer must operate at a jetting frequency below its maximum due to mechanical limitations in the corresponding XYZ movement (for example when accelerating from or decelerating to a stop, or navigating a corner), the toolpath generation algorithm may seek to pass through any such frequency as quickly as possible whenever such jetting frequency within the range of undesirable frequencies identified in the frequency map. In another preferred embodiment, the frequency map is used in real-time by the printer to determine when the jetting frequency may be exciting a frequency of the nozzle assembly. When this occurs, the printer may preferably increase or decrease feed rate and jetting frequency to avoid this frequency. In another embodiment, when such an increased acceleration is not possible for a given printed path (for example, a path with multiple corners which require sustained operation at a forbidden frequency), the printer may reduce its maximum jetting frequency for that path, thus avoiding the resonant frequency bands altogether. The printer may also preferably increase or decrease other print parameters, such as negative pulse width, negative pulse amplitude, reservoir fill level, or others, to increase damping in the nozzle assembly.

The frequency map may also be used to detect problems with a nozzle assembly, such as nozzle breakage. In this case, this information could be used to alert a user to change a broken nozzle, or to cause a quality control test during nozzle assembly manufacturing to fail.

The frequency map may also be generated analytically, using a mathematical model of a nozzle assembly and/or meniscus. For instance, a nozzle geometry can be modeled in a CAD system and that model meshed using a finite-element simulation. The model may then be excited with different frequencies and the resulting amplitudes determining, which can be used to generate an approximate frequency map that can be used with any nozzle assembly of the type modeled. In other embodiments, the liquid within the nozzle and reservoir could be modeled in a similar way, the model excited with expected frequencies, and the resulting movements recorded.

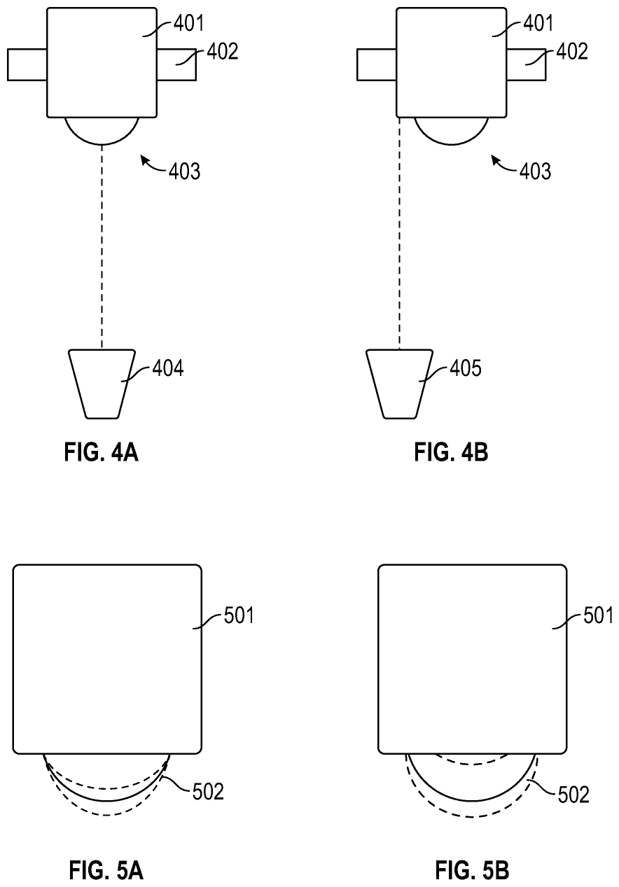

FIG. 4A depicts a first embodiment test setup in which nozzle 401 is affixed to a test apparatus 402. A meniscus of liquid metal 403 is formed on a discharge orifice of nozzle 401. A sensor 404 monitors the movement of meniscus 403 while the nozzle 401 is excited. FIG. 4B depicts a second embodiment test setup similar to that of FIG. 4A only in that a sensor 405 monitors the movement of the nozzle 401 while the nozzle 401 is excited. In alternate embodiments, the sensor may monitor the meniscus at an angle to the axis of discharge from the nozzle, so for instance the nozzle may actively jet in a build process while the meniscus behavior is monitored.

FIG. 5A depicts a nozzle 501 having a meniscus of liquid metal 502 undergoing lesser vibration (exaggerated for illustrative purposes) while FIG. 5B depicts the nozzle 501 wherein the meniscus of liquid metal 502 is undergoing greater vibration such as during jetting at resonant frequencies.

In certain other embodiments, the allowed bands may be translated into allowed feed rate (the relative speed of the printhead with respect to the part being printed) that, given the remaining print parameters, will reduce or eliminate printing in the disallowed bands. Those allowed feed rates may then be utilized to build a mapping of a print job.

It is noted that it may be desirable to alter the above methodologies based on whether the printing mapping is related to a defining edge or an infill pattern, the latter being, generally, less sensitive to the issues associated with decreased printing quality caused by vibration.

It will be understood that the result of the measurements described herein will be a map of frequencies where jetting quality is sufficient to produce parts. For reasons described herein, the map will generally consist of a large “safe” region from 0 Hz to the first onset of out-of-spec jetting performance which we will call the “critical frequency”; in one embodiment that frequency might be 200 Hz. Immediately above this frequency, jetting quality is unacceptable, but at yet higher frequencies, several more “safe” bands of frequencies producing in-spec jetting may be found, though they might be relatively narrow. By definition, these “safe” regions are separated by “unsafe” regions. In one embodiment of an MHD printer, acceptable jetting might be found between 240-260 Hz, 280-300 Hz, 340-350 Hz, and so on—frequencies outside these ranges would be considered “unsafe”. Some of these regions could include frequencies much higher than the critical frequency (200 Hz in our example), allowing significantly higher material deposition rates than would be possible by staying within the range of 0-200 Hz.

It will be understood that to keep a constant distance between deposited drops, the jetting frequency needs to be proportional to the relative speed of the printhead with respect to the part being printed, sometimes referred to as “feed rate” or “traverse speed”. Independent of jetting, and even within the maximum speed capability, this feed rate will be further limited by the maximum acceleration capability of the printer's motion system as well as the shape of the path being traversed—any attempt to exceed this acceleration results in location error. Thus for some paths the maximum jetting frequency may be dictated by motion system, the shape of the part being printed, and the specific area of the part being printed at a given time. As a result, a printer cannot naively print any path at one high jetting rate, because a region of said path might force the printer to slow down, forcing a corresponding reduction in jetting frequency that causes it to enter an “unsafe” region. Several techniques can be used to avoid this problem.

In one simple embodiment, any paths regions that require the printer to decelerate to navigate them are printed only within the lower “safe” region. By contrast any paths which can be executed completely within one of the higher acceptable bands are printed within the highest band that still allows the printer to execute the required XYZ motions.

For some combination of performance map and motion system, the required acceleration and deceleration of the printer's motion system from and to rest at the beginning and end of each path forces the printer to pass through an unacceptable jetting frequency during the acceleration or deceleration. In a preferred embodiment, the printer extends the beginning and end of the path, such that the motion system can accelerate up to speed (without jetting) before the printhead is aligned with the first location to receive material, at which point the jetting begins. Similarly, jetting is stopped at the end of the path, while the printhead continues moving at full speed, decelerating to a stop after jetting ceases. In this way, the entire path is printed at one or more speeds previously determined to be safe. It will be understood that the printer need not be at full speed once jetting begins, so long as the corresponding jetting frequency is in an acceptable range.

In another embodiment, for layers in the part where it produces sufficient resolution, the slicing software or other motion planner can be directed to print the entire layer as a sequence of parallel lines. Combined with the above, this provides the opportunity to print an entire layer at a single high speed.

In another embodiment, when segments of different paths on a layer are colinear and/or tangent to each other, the paths can be combined, allowing the motion system to remain at full speed with only the jetting being switched on and off as appropriate. This too allows the paths to be printed at a single jetting frequency (or as above, within a narrow range), increasing the chances that a higher frequency can be used as there is no concern about leaving what could be a narrow acceptable frequency range.

It should be understood that these techniques can be used alone or in combination on single paths, contiguous regions of a printed layer, entire layers of a part, or entire parts, depending on the printer hardware and nature of the part to be printed.

The terms “bottom”, “below”, “top” and “above” as used herein do not necessarily indicate that a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A method of developing a frequency map for an MHD jetting nozzle, comprising the steps of:
liquifying a build material in the MHD jetting nozzle;
exciting with the MHD jetting nozzle with a series of jetting pulses delivered over a range of frequencies; and
measuring the vibration response of at least one of the MHD jetting nozzle and a meniscus of jetting material formed on a discharge orifice of the MHD jetting nozzle.

2. The method of claim 1 wherein the step of measuring the vibration response is accomplished using high-speed imaging.

3. The method of claim 1 wherein the step of measuring the vibration response is accomplished using laser distance measurement.

4. The method of claim 1 wherein the step of measuring the vibration response is accomplished using laser displacement measurement.

5. The method of claim 1 wherein the step of measuring the vibration response is accomplished using capacitive distance measurement.

6. The method of claim 1 wherein the step of measuring the vibration response is accomplished by measuring acceleration with an accelerometer.

7. The method of claim 1 further comprising the step of forming a frequency map digital file of at least one of allowable jetting frequency bands and disallowed jetting frequency bands.

8. The method of claim 7 further comprising the step of utilizing the frequency map digital file in operating a toolpath generation algorithm to reduce the time spent jetting outside the allowable jetting frequency bands or in the disallowed jetting frequency bands.

9. The method of claim 7 further comprising the step of utilizing the frequency map digital file to adjust at least one printing parameter.

10. The method of claim 9 wherein the at least one printing parameter is a feed rate.

11. The method of claim 9 wherein the at least one printing parameter is a jetting frequency.

13. The method of claim 12 wherein the at least one printing parameter includes at least one of a negative pulse width, a negative pulse amplitude and a reservoir fill level.

14. A method of ameliorating vibration effects during MHD additive manufacturing, comprising the steps of:
retrieving a frequency map digital file from a computer readable non-transient storage medium to a controller controlling the MHD jetting nozzle during an MHD printing process; and
adjusting at least one printing parameter for the MHD jetting process according to the frequency map digital file.

15. The method of claim 14 wherein the at least one printing parameter is a feed rate.

16. The method of claim 14 wherein the at least one printing parameter is a jetting frequency.

17. The method of claim 14 wherein the at least one printing parameter is a negative pulse width, a negative pulse amplitude and a reservoir fill level.

18. A method of ameliorating vibration in an MHD jetting nozzle assembly during MHD additive manufacturing, comprising the steps of:
retrieving a frequency map digital file from a computer readable non-transient storage medium to a controller controlling the MHD jetting nozzle during an MHD printing process;
generating a map of a MHD jetting process accounting for the frequency map digital file, wherein the map of the MHD jetting process includes jetting a first segment of a part at in a first band of allowable jetting frequency and jetting a second segment of the part in a second band of allowable jetting frequencies, wherein each of the frequencies in the second band of allowable jetting frequencies is above a critical frequency.
